(19) United States
(12) Patent Application Publication
(10) Pub. No.: US 2024/0398148 A1
(43) Pub. Date: Dec. 5, 2024

(54) BEVERAGE EXTRACTOR

(71) Applicant: ZOJIRUSHI CORPORATION, Osaka (JP)

(72) Inventors: Masaaki ONBE, Osaka (JP); Shingo TERADA, Osaka (JP); Yusei OZAWA, Osaka (JP)

(21) Appl. No.: 18/687,762

(22) PCT Filed: Aug. 31, 2021
(86) PCT No.: PCT/JP2021/031837

§ 371 Date: Feb. 28, 2024

(51) Int. Cl. A47J 31/18; A47J 31/06

(52) U.S. Cl. CPC A47J 31/18; A47J 31/06

(57) ABSTRACT

A beverage extractor includes a container, a pouring port, a filter unit, and an operation shaft. The filter unit is movable in a top-bottom direction while inscribed in the filter unit. The filter unit includes a filter part and a wall part. The filter part allows a beverage stored in the container to pass therethrough. The wall part is located closer to the pouring port than the filter part. In tilting the container and pouring the beverage through the pouring port into a cup, an over-extracted liquid accumulated under the filter unit is intercepted with the wall part. This makes it possible to suppress pouring of the over-extracted liquid into the cup.

### TECHNICAL FIELD

The present invention relates to a press-type beverage extractor.

### BACKGROUND ART

There is a beverage extractor of a so-called press type conventionally known where, after coffee powder and hot water are poured into a container and coffee is extracted, a filter is pressed down, thereby separating the coffee powder and the extracted coffee from each other. The conventional beverage extractor is described in Patent Literature 1, for example.

### CITATION LIST

### Patent Literature

Patent Literature 1: Japanese Patent Application Laid-Open No. 2015-134023

### SUMMARY OF INVENTION

### Technical Problem

At the press-type beverage extractor, after the filter is pressed down, the coffee as a supernatant is poured into a cup. Meanwhile, the coffee powder remains in an immersed state under the filter. Hence, an over-extracted liquid having a higher concentration than the supernatant liquid is accumulated under the filter. The over-extracted liquid gradually becomes higher in concentration with time. Furthermore, with reduction in the amount of coffee in the beverage extractor, the over-extracted liquid becomes more likely to mix into the coffee to be poured. This causes a problem that the coffee poured from the beverage extractor into a cup largely differs in concentration between a first drink and a last drink.

The present invention has been made in view of the foregoing circumstances, and is intended to provide a press-type beverage extractor with a configuration capable of suppressing pouring of an over-extracted liquid accumulated under a filter unit into a cup.

### Solution to Problem

A liquid container of the present invention is a press-type beverage extractor comprising: a cylindrical container with a closed bottom; a pouring port for pouring a beverage from the container; a filter unit movable in a top-bottom direction while inscribed in the filter unit; and an operation shaft connected to the filter unit, wherein the filter unit includes: a filter part allowing a beverage stored in the container to pass therethrough; and a wall part with which the beverage is intercepted, and the wall part is located closer to the pouring port than the filter part.

According to this beverage extractor, in tilting the container and pouring the beverage through the pouring port into a cup, an over-extracted liquid accumulated under the filter unit is intercepted with the wall part. This makes it possible to suppress pouring of the over-extracted liquid into the cup.

In particular, it is desirable that, while the container is tilted toward the pouring port, a boundary line between the wall part and the filter part be substantially horizontal. By doing so, on condition that the area of the wall part is constant, it becomes possible to maximize the amount of the interceptable over-extracted liquid. Thus, it is possible for the over-extracted liquid accumulated under the filter unit to be intercepted more favorably.

It is desirable that the filter part have an area in a top view that is less than a half of the area of the filter unit in a top view. This makes it possible to further increase the amount of the over-extracted liquid to be intercepted with the wall part. Thus, it is possible for the over-extracted liquid accumulated under the filter unit to be intercepted more favorably.

It is desirable that the beverage extractor further comprise a detent unit that regulates rotation of the filter unit relative to the pouring port. This allows the wall part of the filter unit to be always arranged closer to the pouring port. Thus, it is possible to further suppress pouring of the over-extracted liquid accumulated under the filter unit into the cup.

It is desirable that the beverage extractor further comprise a plate arranged over the filter unit. This makes it possible to suppress upward diffusion of raw powder having passed through the filter part.

It is desirable that the plate be movable up and down relative to the filter unit. By doing so, a clearance is formed between the filter unit and the plate in pressing down the filter unit, thereby allowing the beverage to pass through this clearance. After the filter unit is pressed down to a bottom part of the container, the plate moves down and covers an upper surface of the filter unit. Thus, it becomes possible to further suppress diffusion of the over-extracted liquid and raw powder into the beverage over the over-extracted liquid and the raw powder.

It is desirable that the beverage extractor further comprise a pawl part that limits a range of upward movement of the plate relative to the filter unit. By doing so, it becomes possible to prevent the plate from lifting excessively relative to the filter unit.

### Advantageous Effects of Invention

According to the present invention, in tilting the container and pouring the beverage through the pouring port into a cup, the over-extracted liquid accumulated under the filter unit is intercepted with the wall part. This makes it possible to suppress pouring of the over-extracted liquid into the cup.

### BRIEF DESCRIPTION OF DRAWINGS

FIG. 1 is a side view of a beverage extractor.

FIG. 2 is a top view of the beverage extractor.

FIG. 3 is a longitudinal sectional view of the beverage extractor.

FIG. 4 is a side view of a filter unit, an operation shaft, and a plate.

FIG. 5 is a perspective view of the filter unit, the operation shaft, and the plate.

FIG. 6 is a top view of the filter unit.

FIG. 7 is a view schematically showing the beverage extractor.

FIG. 8 is a view schematically showing the beverage extractor.

### DESCRIPTION OF EMBODIMENTS

An embodiment of the present invention will now be described with reference to the drawings.

### <1. Beverage Extractor According to Embodiment>

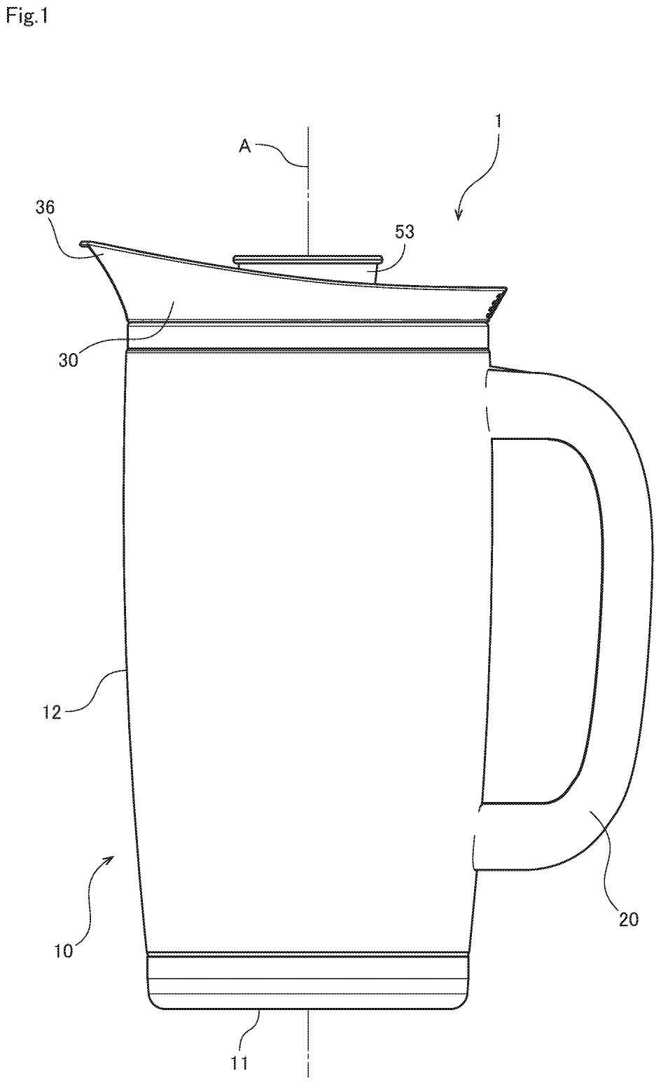

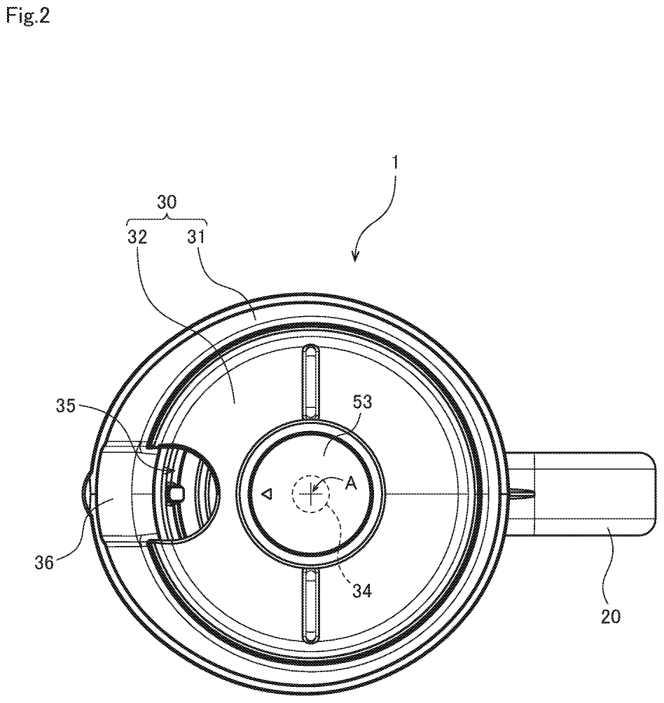

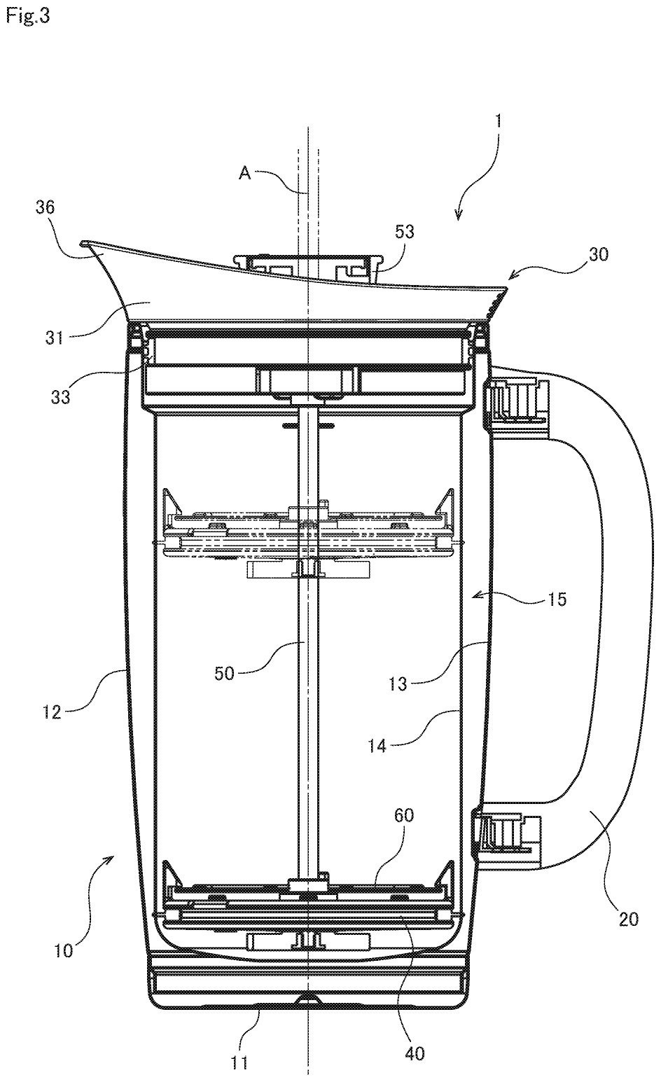

FIG. 1 is a side view of a beverage extractor 1 according to one embodiment of the present invention. FIG. 2 is a top view of the beverage extractor 1. FIG. 3 is a longitudinal sectional view of the beverage extractor 1. The beverage extractor 1 is a so-called press-type extractor where, raw powder and hot water or water are poured into the beverage extractor 1, a beverage is extracted from the raw powder, and a filter unit 40 is pressed down, thereby separating the raw powder and the extracted beverage from each other. The raw powder is milled coffee beans (coffee powder) or tea leaves, for example. The extracted beverage is coffee, black tea, or green tea, for example.

As shown in FIGS. 1 to 3, the beverage extractor 1 includes a container 10, a handle 20, a stopper unit 30, the filter unit 40, an operation shaft 50, and a plate 60.

The container 10 is a cylindrical body member with a closed bottom. The container 10 includes a bottom part 11 of a flat plate shape, and a circular cylindrical lateral part 12 extending upward from a peripheral portion of the bottom part 11. Space allowing storage of a beverage is present inside the container 10. Stainless steel or glass is generally used as a material for the container 10, for example. The container 10 of the present embodiment has a vacuum double structure. Specifically, the container 10 includes a cylindrical outer bottle 13 with a closed bottom, and a cylindrical inner bottle 14 with a closed bottom arranged inside the outer bottle 13. A vacuum layer 15 is interposed between the outer bottle 13 and the inner bottle 14. This allows a beverage stored inside the container 10 to be kept warm or cold.

The handle 20 is a member to be grasped by a user in carrying the beverage extractor 1 or pouring a beverage from the beverage extractor 1 into a cup. The handle 20 is fixed to an outer surface of the container 10. A pouring port 35 described later and the handle 20 are located on opposite sides to each other with respect to a center axis A of the container 10.

The stopper unit 30 is a unit covering the top of the container 10. As shown in FIGS. 2 and 3, the stopper unit 30 includes a stopper frame 31 and a stopper cover 32. The stopper frame 31 is a substantially ring-like member. The stopper frame 31 is attached to an upper end of the lateral part 12 of the container 10. The stopper frame 31 has a lower portion inserted in an opening at the top of the container 10. The stopper cover 32 is a member having a substantially circular plate shape. The stopper cover 32 is fitted internally to the stopper frame 31.

As shown in FIG. 3, the stopper unit 30 includes a ring-like first packing 33. The first packing 33 is attached to an outer peripheral surface of the lower portion of the stopper frame 31. With the stopper unit 30 attached to the container 10, the first packing 33 tightly contacts an inner peripheral surface of the lateral part 12 of the container 10 while elastically deformed. By doing so, a clearance between the container 10 and the stopper unit 30 is sealed. This suppresses leakage of a beverage in the container 10 to the outside from between the container 10 and the stopper unit 30.

As shown in FIG. 2, the stopper cover 32 includes a first through hole 34 and a pouring port 35. The first through hole 34 is a hole for insertion of the operation shaft 50 described later. The first through hole 34 penetrates a central portion of the stopper cover 32 in a top-bottom direction. The pouring port 35 is an opening for pouring of a beverage from the container 10 into a cup. The pouring port 35 is a cutout formed at a marginal portion of the stopper cover 32.

The stopper frame 31 includes a beak part 36. The beak part 36 is provided at a position at a marginal portion of the stopper frame 31 and external to the pouring port 35, and projects externally in a radial direction. The beak part 36 has a groove shape that gradually converges toward an outer end thereof. The pouring port 35 and the beak part 36, and the handle 20 described above are located on opposite sides to each other with respect to the center axis A of the container 10. When a user holds the handle 20 and tilts the beverage extractor 1 toward the pouring port 35, a beverage in the container 10 is poured into a cup through the pouring port 35 and the beak part 36.

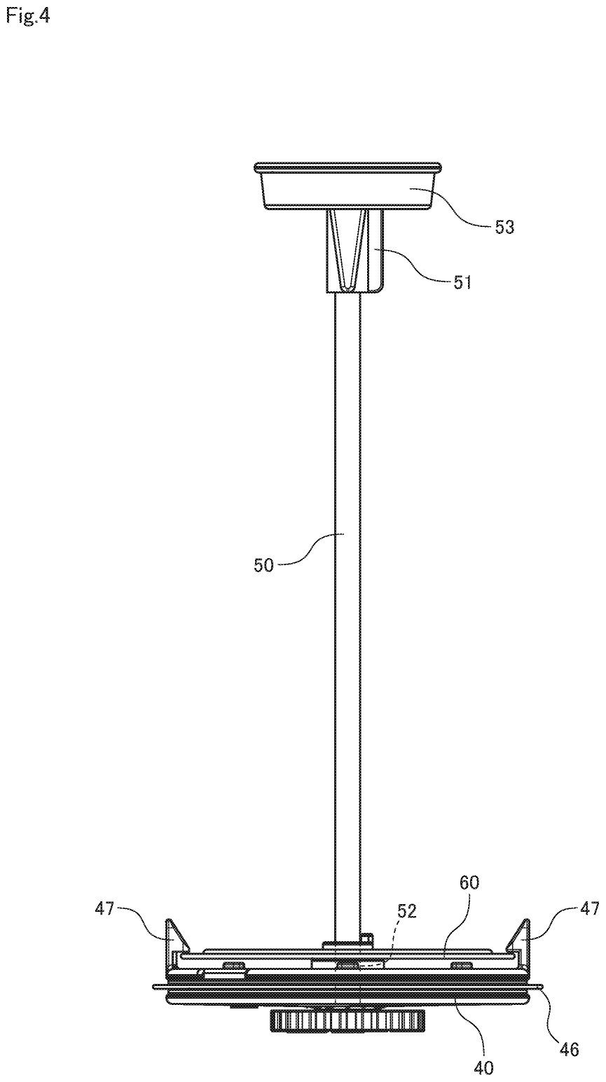

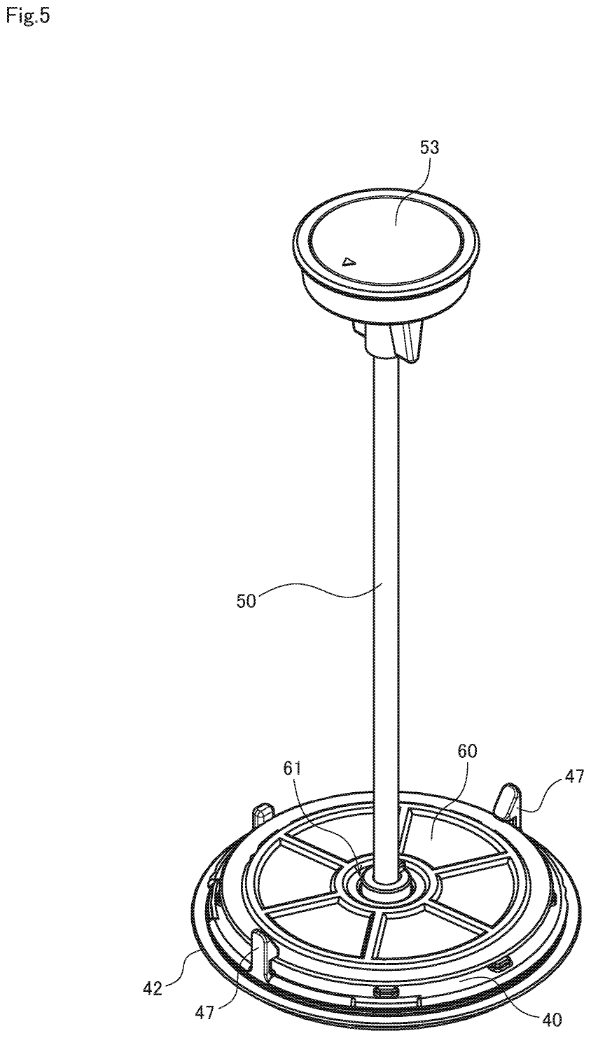

FIG. 4 is a side view of the filter unit 40, the operation shaft 50, and the plate 60. FIG. 5 is a perspective view of the filter unit 40, the operation shaft 50, and the plate 60. As shown in FIGS. 4 and 5, the filter unit 40 is fixed to a lower end portion of the operation shaft 50. The plate 60 is arranged over the filter unit 40.

As shown in FIG. 3, the filter unit 40 and the plate 60 are arranged inside the container 10. The filter unit 40, the operation shaft 50, and the plate 60 are movable in the top-bottom direction relative to the container 10 between a higher position indicated by alternate long and two short dashed lines indicated in FIG. 3 and a lower position indicated by solid lines in FIG. 3.

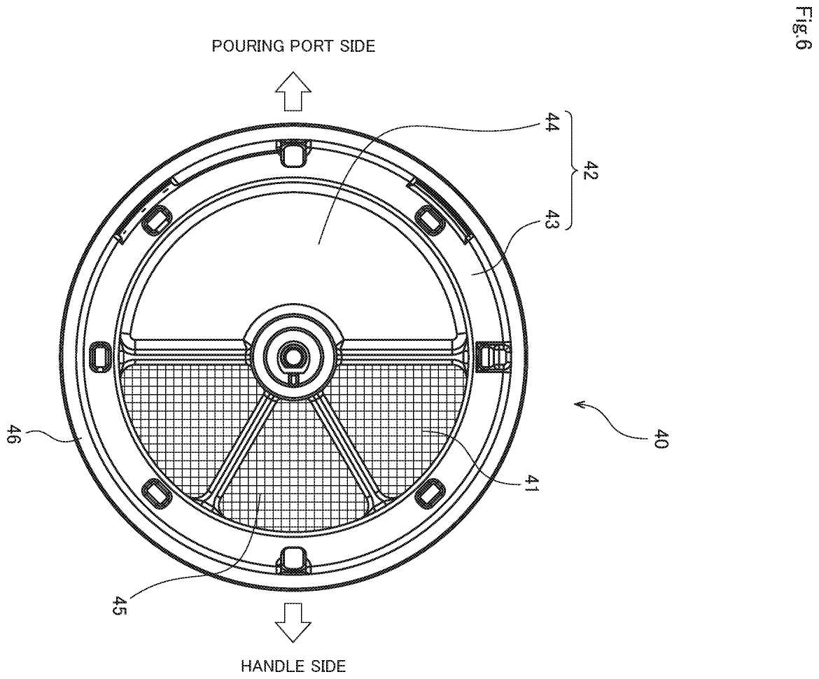

The filter unit 40 is a unit for separating raw powder and a beverage from each other in the container 10. FIG. 6 is a top view of the filter unit 40. As shown in FIGS. 5 and 6, the filter unit 40 has an outer shape like a circular plate. The filter unit 40 is arranged in a horizontal posture inside the container 10. The filter unit 40 moves in the top-bottom direction while inscribed in the lateral part 12 of the container 10.

As shown in FIG. 6, the filter unit 40 includes a filter 41 and a holder 42. The filter 41 has a flat plate shape, and has a large number of pores in a mesh pattern penetrating the filter 41 in the top-bottom direction. Each of the pores of the filter 41 has such a size as will prohibit passage of raw powder therethrough. The holder 42 is a resin member holding the filter 41. The holder 42 is formed integrally with the filter 41 by insert molding.

As shown in FIG. 6, the holder 42 includes a frame part 43 and a wall part 44. The frame part 43 is a ring-like part extending along an inner peripheral surface of the container 10. The wall part 44 is a part extending in a flat plate shape in a part of a region inside the frame part 43. Of the region inside the frame part 43, the other part beside the wall part 44 functions as a filter part 45 where the filter 41 is exposed. Specifically, the filter unit 40 includes the filter part 45 allowing a beverage to pass therethrough, and the wall part 44 for intercepting the beverage that are provided inside the frame part 43.

The wall part 44 is located closer to the pouring port 35 than the filter part 45. In the present embodiment, of the region inside the frame part 43 of the filter unit 40, the filter part 45 covers about a half of the region closer to the handle 20 and the wall part 44 covers about a half of the region closer to the pouring port 35 in a top view.

The filter unit 40 includes a ring-like second packing 46. The second packing 46 is attached to an outer peripheral surface of the frame part 43 of the holder 42. The second packing 46 tightly contacts the inner peripheral surface of the container 10 while elastically deformed. By doing so, an outer peripheral surface of the filter unit 40 and the inner peripheral surface of the container 10 are sealed with each other. This suppresses movement of raw powder between the outer peripheral surface of the filter unit 40 and the inner peripheral surface of the container 10.

The operation shaft 50 is a rod-like member for moving the filter unit 40 up and down. The operation shaft 50 extends linearly along the center axis A of the container 10. The lower end portion of the operation shaft 50 is connected to a central portion of the filter unit 40. An upper end portion of the operation shaft 50 extends up above the stopper cover 32 through the first through hole 34 at the stopper cover 32. A knob part 53 to be grasped by a user is provided at the upper end portion of the operation shaft 50. A user of the beverage extractor 1 is capable of moving the filter unit 40 and the plate 60 located inside the container 10 in the top-bottom direction by moving the operation shaft 50 up and down while holding the knob part 53.

As shown in FIG. 4, the operation shaft 50 includes a first detent part 51. The first detent part 51 has an imperfect circular shape in a top view. More specifically, the first detent part 51 has a planar portion (D-cut), a projection, or a recess in a top view. The stopper cover 32 includes a first fitting part (not shown in the drawings) having an imperfect circular shape conforming to the first detent part 51. The first detent part 51 of the operation shaft 50 fits over the first fitting part of the stopper cover 32. By doing so, rotation of the operation shaft 50 relative to the stopper unit 30 is regulated at a predetermined position.

As shown in FIG. 4, the operation shaft 50 includes a second detent part 52 provided at the lower end portion thereof. The second detent part 52 has an imperfect circular shape in a top view. More specifically, the second detent part 52 has a planar portion (D-cut), a projection, or a recess in a top view. The holder 42 of the filter unit 40 includes a second fitting part (not shown in the drawings) having an imperfect circular shape conforming to the second detent part 52. The second detent part 52 of the operation shaft 50 fits over the second fitting part of the filter unit 40. By doing so, rotation of the filter unit 40 relative to the operation shaft 50 is regulated at a predetermined position.

As described above, rotation of the operation shaft 50 relative to the stopper unit 30 is regulated at a predetermined position using the first detent part 51 and the first fitting part. Furthermore, rotation of the filter unit 40 relative to the operation shaft 50 is regulated at a predetermined position using the second detent part 52 and the second fitting part. As a result, rotation of the filter unit 40 relative to the pouring port 35 of the stopper unit 30 about the center axis A is regulated at a predetermined position. Specifically, the first detent part 51, the first fitting part, the second detent part 52, and the second fitting part form a detent unit that regulates rotation of the filter unit 40 relative to the pouring port 35. By doing so, the wall part 44 of the filter unit 40 is always maintained in a state of being closer to the pouring port 35 than the filter part 45.

Namely, the detent unit is to always maintain the wall part 44 of the filter unit 40 in a state of being closer to the pouring port 35 than the filter part 45. If the positions of the first detent part 51 and the second detent part 52 are not such positions as will locate the wall part 44 of the filter unit 40 closer to the pouring port 35 than the filter part 45, for example, the operation shaft 50 may be configured not to fit over the stopper unit 30.

The plate 60 is a plate arranged in a horizontal posture over the filter unit 40. While much of raw powder in the container 10 is trapped under the filter unit 40, a small portion of the raw powder passes through the pores of the filter part 45 to move up over the filter unit 40. The plate 60 is a plate for suppressing upward diffusion of the raw powder having passed through the filter part 45.

The plate 60 is a circular plate having a slightly smaller diameter than the filter unit 40. The plate 60 has a second through hole 61. The second through hole 61 penetrates a central portion of the plate 60 in the top-bottom direction. The operation shaft 50 is inserted in the second through hole 61 of the plate 60. This makes the plate 60 movable up and down along the operation shaft 50. Specifically, the plate 60 is movable up and down relative to the filter unit 40.

The holder 42 of the filter unit 40 includes pawl parts 47 in a pair. Each of the pawl parts 47 in a pair extends upward from the frame part 43 of the holder 42, and has a tip projecting internally (toward the center axis A). When the plate 60 moves up relative to the filter unit 40, the pawl parts 47 in a pair come into contact with an upper surface of a marginal portion of the plate 60. This limits a range of the upward movement of the plate 60 relative to the filter unit 40. As a result, it becomes possible to prevent the plate 60 from lifting excessively relative to the filter unit 40.

For extraction of a beverage using the beverage extractor 1, an assembly composed of the stopper unit 30, the filter unit 40, the operation shaft 50, and the plate 60 is first detached from the container 10. Next, raw powder (coffee powder, for example) and hot water or water are introduced into the container 10. Then, the assembly is attached to the container 10. After lapse of a predetermined extraction period thereafter, a user holds the knob part 53 and presses down the operation shaft 50. This moves the filter unit 40 down inside the container 10. By doing so, of the raw powder and an extracted beverage, only the beverage passes through the filter part 45. The raw powder is depressed toward the bottom part 11 of the container 10 with the filter unit 40. Next, the user holds the handle 20 and tilts the beverage extractor 1 toward the pouring port 35. By doing so, a supernatant liquid of the beverage stored over the filter unit 40 is poured into a cup through the pouring port 35 and the beak part 36.

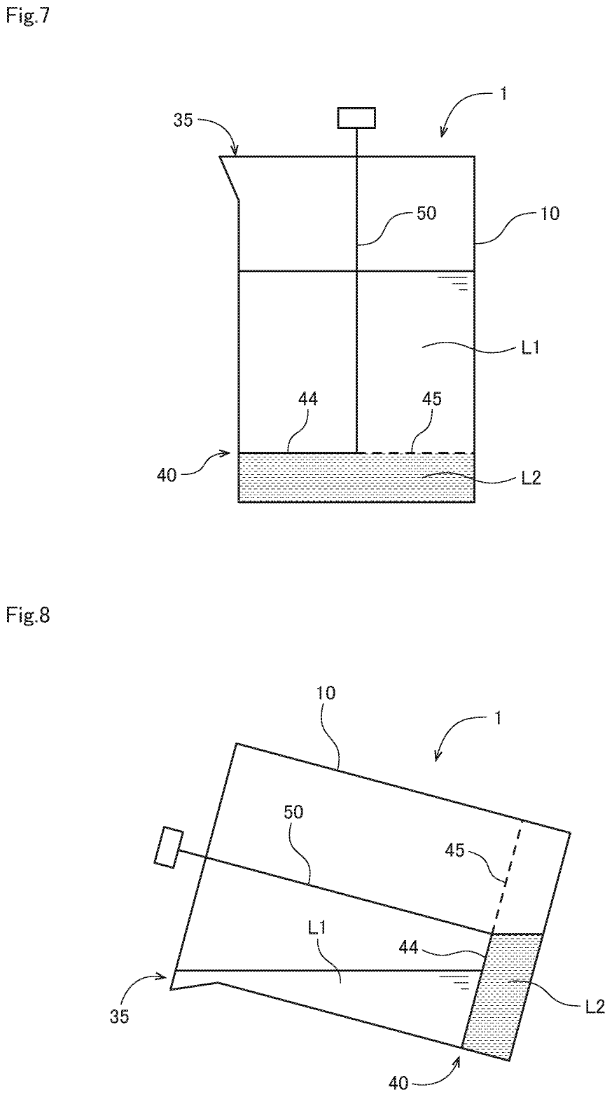

FIGS. 7 and 8 are views each schematically showing the beverage extractor 1 where a beverage has been extracted from raw powder. If the container 10 is left as it is for a while after extraction of the beverage, a component of the beverage is extracted excessively from the raw powder in an area under the filter unit 40. As a result, as shown in FIG. 7, an over-extracted liquid L2 having a higher concentration than a supernatant liquid L1 is accumulated under the filter unit 40. In the beverage extractor 1 of the present embodiment, however, the over-extracted liquid L2 is intercepted with the wall part 44 in tilting the container 10 and pouring the beverage into a cup, as shown in FIG. 8. This makes it possible to suppress pouring of the over-extracted liquid L2 into the cup.

In particular, in the filter unit 40 of the present embodiment, a boundary line between the wall part 44 and the filter part 45 is substantially horizontal while the container 10 is tilted toward the pouring port 35. By doing so, on condition that the area of the wall part 44 is constant, it becomes possible to maximize the amount of the interceptable over-extracted liquid L2. Thus, it is possible for the over-extracted liquid L2 accumulated under the filter unit 40 to be intercepted more favorably.

In the filter unit 40 of the present embodiment, the area of the filter part 45 in a top view is less than a half of the area of the filter unit 40 in a top view. This makes it possible to further increase the amount of the over-extracted liquid L2 to be intercepted with the wall part 44. Thus, it is possible for the over-extracted liquid L2 accumulated under the filter unit 40 to be intercepted more favorably.

In the configuration of the present embodiment, the presence of the wall part 44 causes a large resistance in pressing down the filter unit 40. In response to this, the meshes of the filter 41 might be increased for reducing a resistance in pressing down the filter unit 40. However, increasing the meshes of the filter 41 causes raw powder to pass through the filter part 45 and to move up easily. In this regard, in the beverage extractor 1 of the present embodiment, the plate 60 is arranged over the filter unit 40. This makes it possible to suppress upward diffusion of the raw powder having passed through the filter part 45. As a result, it is possible to suppress pouring of the raw powder into a cup.

In the configuration of the present embodiment, the plate 60 is movable up and down relative to the filter unit 40. By doing so, a clearance is formed between the filter unit 40 and the plate 60 in pressing down the filter unit 40, thereby allowing a beverage to pass through this clearance. After the filter unit 40 is pressed down to the lower position, the plate 60 moves down and covers an upper surface of the filter unit 40. Thus, it becomes possible to further suppress diffusion of the over-extracted liquid L2 and raw powder into the beverage over the over-extracted liquid L2 and the raw powder.

### <2. Modifications>

While one embodiment of the present invention has been described above, the present invention is not intended to be limited to the above-described embodiment.

In the above-described embodiment, the container 10 has a vacuum double structure. However, the container 10 may have a single structure.

In the above-described embodiment, the pawl parts 47 for limiting a range of upward movement of the plate 60 are provided at the filter unit 40. However, an externally-projecting pawl part may be provided at an outer peripheral surface of the operation shaft 50 and a range of upward movement of the plate 60 may be limited using this pawl part.

In the above-described embodiment, the plate 60 is movable up and down relative to the filter unit 40. However, the position of the plate 60 relative to the filter unit 40 may be fixed. For example, the plate 60 may be fixed to the operation shaft 50 at a position over the upper surface of the filter unit 40 with a slight clearance from this upper surface.

In the above-described embodiment, of the region inside the frame part 43 of the filter unit 40, the filter part 45 covers about a half of the region and the wall part 44 covers about the other half in a top view. However, the area ratio of the wall part 44 at the filter unit 40 is not limited to the ratio of the example given above.

The shape of a detailed part of the beverage extractor may differ from that illustrated in each of the drawings of the present application. Furthermore, all the elements appearing in the above-described embodiment or modifications may be combined, as appropriate, within a range not causing inconsistency.

### REFERENCE SIGNS LIST

1 Beverage extractor
10 Container
11 Bottom part
12 Lateral part
13 Outer bottle
14 Inner bottle
15 Vacuum layer
20 Handle
30 Stopper unit
31 Stopper frame
32 Stopper cover
33 First packing
34 First through hole
35 Pouring port
36 Beak part
40 Filter unit
41 Filer
42 Holder
43 Frame part
44 Wall part
45 Filter part
46 Second packing
47 Pawl part
50 Operation shaft
51 First detent part
52 Second detent part
53 Knob part
60 Plate
61 Second through hole
A Center axis
L1 Supernatant liquid

L2 Over-extracted liquid

1. A press-type beverage extractor comprising:
a cylindrical container with a closed bottom;
a pouring port for pouring a beverage from said container;
a filter unit movable in a top-bottom direction while inscribed in said filter unit; and
and an operation shaft connected to said filter unit, wherein
said filter unit includes:
a filter part allowing a beverage stored in said container to pass therethrough; and
a wall part with which said beverage is intercepted, and
said wall part is located closer to said pouring port than said filter part.

2. The beverage extractor according to claim 1, wherein
while said container is tilted toward said pouring port, a boundary line between said wall part and said filter part is substantially horizontal.

3. The beverage extractor according to claim 1, wherein
said filter part has an area in a top view that is less than a half of the area of said filter unit in a top view.

4. The beverage extractor according to claim 1, further comprising:
a detent unit that regulates rotation of said filter unit relative to said pouring port.

5. The beverage extractor according to claim 1, further comprising:
a plate arranged over said filter unit.

6. The beverage extractor according to claim 5, wherein
said plate is movable up and down relative to said filter unit.

7. The beverage extractor according to claim 6, further comprising:
a pawl part that limits a range of upward movement of said plate relative to said filter unit.
